(19) United States
(12) Patent Application Publication
(10) Pub. No.: US 2025/0125926 A1
(43) Pub. Date: Apr. 17, 2025

(54) CONFIGURING CSI-RS FOR CSI FEEDBACK ASSOCIATED WITH DL TRANSMISSION FROM MULTIPLE TRPs

(71) Applicant: Telefonaktiebolaget LM Ericsson (publ), Stockholm (SE)

(72) Inventors: Siva Muruganathan, Stittsville (CA); Andreas Nilsson, Göteborg (SE); Shiwei Gao, Nepean (CA)

(21) Appl. No.: 18/685,258

(22) PCT Filed: Aug. 23, 2022
(86) PCT No.: PCT/IB2022/057898

§ 371 Date: Feb. 21, 2024

Related U.S. Application Data
(60) Provisional application No. 63/236,134, filed on Aug. 23, 2021.

(51) Int. Cl. H04L 5/00; H04W 72/231; H04W 72/542

(52) U.S. Cl. CPC H04L 5/0051; H04L 5/0035; H04L 5/0053; H04W 72/231; H04W 72/542

(57) ABSTRACT

Systems and methods are disclosed that relate to configuring Channel State Information Reference Signal (CSI-RS) for Channel State Information (CSI) feedback associated with downlink transmission from multiple Transmission and Reception Points (TRPs). In one embodiment, a method performed by a User Equipment (UE) comprises receiving information that indicates, for one or more CSI-RS ports in one or more CSI-RS resources in a CSI-RS resource set: (a) multiple Transmission Configuration Indicator (TCI) states associated to each of the CSI-RS resource(s), (b) a single TCI state for each of multiple CSI-RS resources in the CSI-RS resource set, wherein the multiple CSI-RS resources are fully overlapping in time and frequency and each of the multiple CSI-RS resources is associated to a different TCI state, or both (a) and (b). The method further comprises performing channel measurement, determining a channel rank, computing a channel quality, and sending feedback comprising the rank and channel quality.

### RELATED APPLICATIONS

This application claims the benefit of provisional patent application Ser. No. 63/236,134, filed Aug. 23, 2021, the disclosure of which is hereby incorporated herein by reference in its entirety.

### TECHNICAL FIELD

The present disclosure is related to a wireless communication system and, more specifically, to Channel State Information (CSI) feedback in a wireless communication system.

### BACKGROUND

### Codebook-Based Precoding

Multi-antenna techniques can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

The Third Generation Partnership Project (3GPP) New Radio (NR) standard is currently evolving with enhanced MIMO support. A core component in NR is the support of MIMO antenna deployments and MIMO related techniques like, for instance, spatial multiplexing. The spatial multiplexing mode is aimed for high data rates in favorable channel conditions. An illustration of the spatial multiplexing operation is provided in FIG. 1.

As shown in FIG. 1, the information carrying symbol vector s is multiplied by an NT×r precoder matrix W, which serves to distribute the transmit energy in a subspace of the NT (corresponding to NT antenna ports) dimensional vector space. The precoder matrix is typically selected from a codebook of possible precoder matrices, and typically indicated by means of a Precoder Matrix Indicator (PMI), which specifies a unique precoder matrix in the codebook for a given number of symbol streams. The r symbols in s each correspond to a layer, and r is referred to as the transmission rank. In this way, spatial multiplexing is achieved since multiple symbols can be transmitted simultaneously over the same Time/Frequency Resource Element (TFRE). The number of symbols r is typically adapted to suit the current channel properties.

NR uses Orthogonal Frequency Division Multiplexing (OFDM) in the downlink (and Discrete Fourier Transform (DFT) precoded OFDM in the uplink for rank-1 transmission) and hence the received NR×1 vector yₙ for a certain TFRE on subcarrier n (or alternatively data TFRE number n) is modeled by

yₙ=HₙWsₙ+eₙ

where eₙ is a noise/interference vector obtained as realizations of a random process. The precoder W can be a wideband precoder, which is constant over frequency, or frequency selective.

The precoder matrix W is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to the User Equipment (UE).

In closed-loop precoding for the NR downlink, the UE transmits, based on channel measurements in the downlink, recommendations to the NR base station (gNB) of a suitable precoder to use. The gNB configures the UE to provide feedback according to CSI-ReportConfig and may transmit Channel State Information Reference Signal (CSI-RS) and configure the UE to use measurements of CSI-RS to feedback recommended precoding matrices that the UE selects from a codebook. A single precoder that is supposed to cover a large bandwidth (wideband precoding) may be fed back. It may also be beneficial to match the frequency variations of the channel and instead feedback a frequency-selective precoding report, e.g. feeding back several precoders where one precoder corresponds to one subband. This is an example of the more general case of Channel State Information (CSI) feedback, which also encompasses feeding back other information than recommended precoders to assist the gNB in subsequent transmissions to the UE. Such other information may include Channel Quality Indicators (CQIs) as well as transmission Rank Indicator (RI).

In NR, CSI feedback can be either wideband, where one CSI is reported for the entire channel bandwidth, or frequency-selective, where one CSI is reported for each subband. Subband is defined as a number of contiguous Physical Resource Blocks (PRBs) ranging between 4-32 PRBs depending on the band width part (BWP) size. Generally, all the PRBs in the system bandwidth are divided into different subbands where each subband consists of a given number of PRBs. In contrast, wideband involves all the PRBs in the system bandwidth. As mentioned above, a UE may feedback a single precoder that takes into account the measurements from all PRBs in the system bandwidth if it is configured to report wideband PMI. Alternatively, if the UE is configured to report subband PMI, a UE may feedback multiple precoders with one precoder per subband. In addition to the subband precoders, the UE may also feedback the wideband PMI.

Given the CSI feedback from the UE, the gNB determines the transmission parameters it wishes to use to transmit to the UE, including the precoding matrix, transmission rank, and modulation and coding scheme (MCS). These transmission parameters may differ from the recommendations the UE makes. The transmission rank, and thus the number of spatially multiplexed layers, is reflected in the number of columns of the precoder W. For efficient performance, it is important that a transmission rank that matches the channel properties is selected.

### 2D Antenna Arrays

Embodiments of the solution(s) described herein may be used with two-dimensional (2D) antenna arrays and some of the presented embodiments use such antennas. Such antenna arrays may be (partly) described by the number of antenna columns corresponding to the horizontal dimension Nₕ, the number of antenna rows corresponding to the vertical dimension Nᵥ, and the number of dimensions corresponding to different polarizations Nₚ. The total number of antennas is thus N=NₕNᵥNₚ. The concept of an antenna is non-limiting in the sense that it can refer to any virtualization (e.g., linear mapping) of the physical antenna elements. For example, pairs of physical sub-elements could be fed the same signal, and hence share the same virtualized antenna port.

An example of a 4×4 array with dual-polarized antenna elements is illustrated below in FIG. 2. In other words, FIG. 2 is an illustration of a two-dimensional antenna array of dual-polarized antenna elements (Nₚ=2), with Nₕ=4 horizontal antenna elements and Nᵥ=4 vertical antenna elements.

Precoding may be interpreted as multiplying the signal with different beamforming weights for each antenna prior to transmission. A typical approach is to tailor the precoder to the antenna form factor, i.e. taking into account Nₕ, Nᵥ, and Nₚ when designing the precoder codebook.

### Channel State Information Reference Signals (CSI-RS)

For CSI measurement and feedback, CSI-RS are defined. A CSI-RS is transmitted on each antenna port and is used by a UE to measure downlink channel between each of the transmit antenna ports and each of its receive antenna ports. The transmit antenna ports are also referred to as CSI-RS ports. The supported number of antenna ports in NR are {1, 2, 4, 8, 12, 16, 24, 32}. By measuring the received CSI-RS, a UE can estimate the channel that the CSI-RS is traversing, including the radio propagation channel and antenna gains. The CSI-RS for the above purpose is also referred to as Non-Zero Power (NZP) CSI-RS.

CSI-RS can be configured to be transmitted in certain Resource Elements (REs) in a slot and certain slots. FIG. 3 shows an example of CSI-RS REs for 12 antenna ports, where 1RE per RB per port is shown.

In addition, Interference Measurement Resource (IMR) is also defined in NR for a UE to measure interference. An IMR resource contains 4 REs, either 4 adjacent REs in frequency in the same OFDM symbol or 2 by 2 adjacent REs in both time and frequency in a slot. By measuring both the channel based on NZP CSI-RS and the interference based on an IMR, a UE can estimate the effective channel and noise plus interference to determine the CSI, i.e. rank, precoding matrix, and the channel quality.

Furthermore, a UE in NR may be configured to measure interference based on one or multiple NZP CSI-RS resource.

### CSI Framework in NR

In NR, a UE can be configured with multiple CSI reporting settings and multiple CSI-RS resource settings. Each resource setting can contain multiple resource sets, and each resource set can contain up to 8 CSI-RS resources. For each CSI reporting setting, a UE feeds back a CSI report.

Each CSI reporting setting contains at least the following information:
A CSI-RS resource set for channel measurement.
An IMR resource set for interference measurement
Optionally, a CSI-RS resource set for interference measurement
Time-domain behavior, i.e. periodic, semi-persistent, or aperiodic reporting
Frequency granularity, i.e. wideband or subband
CSI parameters to be reported such as RI, PMI, CQI, and CSI-RS resource indicator (CRI) in case of multiple CSI-RS resources in a resource set
Codebook types, i.e. type I or II, and codebook subset restriction
Measurement restriction enabled or disabled
Subband size. One out of two possible subband sizes is indicated, the value range depends on the bandwidth of the downlink bandwidth part (BWP). One CQI/PMI (if configured for subband reporting) is fed back per subband).

When the CSI-RS resource set in a CSI report setting contains multiple CSI-RS resources, one of the CSI-RS resources is selected by a UE and a CSI-RS resource indicator (CRI) is also reported by the UE to indicate to the gNB about the selected CSI-RS resource in the resource set, together with RI, PMI and CQI associated with the selected CSI-RS resource. The network may then transmit the different CSI-RS resources using different MIMO precoders or by using different beam directions.

For aperiodic CSI reporting in NR, more than one CSI report settings, each with a different CSI-RS resource set for channel measurement and/or different resource set for interference measurement, can be configured and triggered at the same time, i.e. with a single trigger command in the downlink control channel from the gNB to the UE. In this case, multiple CSI reports are measured, computed, aggregated, and sent from the UE to the gNB in a single Physical Uplink Shared Channel (PUSCH) message.

### MU-MIMO

With Multi-User MIMO (MU-MIMO), two or more UEs in the same cell are co-scheduled on the same time-frequency resource. That is, two or more independent data streams are transmitted to different UEs at the same time, and the Spatial Domain (SD) is used to separate the respective streams. By transmitting several streams simultaneously, the capacity of the system can be increased. This, however, comes at the cost of reducing the Signal to Interference plus Noise Ratio (SINR) per stream, as the power must be shared between streams, and the streams will cause interference to each-other.

One central part of MU-MIMO is to obtain accurate CSI that enables null forming between co-scheduled UEs. Therefore, support has been added in Long Term Evolution (LTE) Release 14 and NR Releases15-16 for codebooks that provide more detailed CSI than the traditional single DFT-beam precoders. These codebooks, referred to as Advanced CSI (LTE), Type II codebooks (NR Release 15), and enhanced Type II codebooks (NR Release 16) can be described as a set of precoders where each precoder is created from multiple DFT beams. A multi-beam precoder may be defined as a linear combination of several DFT precoder vectors as

$$w = {\sum }_{i} {c}_{i} \cdot {w}_{2 D , DP} ( {k}_{i} , {l}_{i} , {ϕ}_{i} ) ,$$

where {cᵢ} may be general complex coefficients. Such a multi-beam precoder may more accurately describe the UE's channel and may thus bring an additional performance benefit compared to a DFT precoder, especially for MU-MIMO where rich channel knowledge is desirable in order to perform null-forming between co-scheduled UEs.

Another way to attain accurate CSI at a gNB is to schedule the UEs with Sounding Reference Signal (SRS) transmission to estimate the uplink (UL) channel, and then use reciprocity to attain the downlink (DL) channel.

### Non-PMI CSI Feedback

To improve link adaptation in reciprocity-based operation and/or MU-MIMO operation, a non-PMI feedback scheme is supported in NR in which the gNB transmits precoded CSI-RS to a UE. An example is shown in FIG. 4, where each precoded CSI-RS port corresponds to a MIMO layer, wherein r is the number of MIMO layers (note there are r CSI-RS ports in a CSI-RS resource shown in the example). The UE estimates the actual rank and CQI based on the received CSI-RS and the actual interference seen by the UE and feeds back the estimated rank and CQI. For rank and CQI calculation, the UE assumes a single precoder for each rank. The precoder for rank k is a matrix formed by the first k columns of an P×P identity matrix, where P is the number of precoded CSI-RS ports and P=r in the example. In the example shown in FIG. 4, the r CSI-RS ports are transmitted in a single CSI-RS resource.

The precoding matrix W_{N}_{_{T×r}} can be derived either based on reciprocity-based operation or using the accurate CSI obtained from Type II CSI feedback, enhanced Type II CSI feedback, etc. In MU-MIMO, a null formed precoder may be formed taking into account which UEs are to be co-scheduled, and the null formed precoder may be used as the precoding matrix W_{N}_{_{T×r}}.

In reciprocity-based operation, uplink channel is estimated based on uplink reference signals such as SRS. In a Time Division Duplexing (TDD) system, the same carrier frequency is used for both downlink and uplink. So, the estimated uplink channel can be used to derive downlink precoding matrix W_{N}_{_{T×r}}. However, since the downlink interference experienced at a UE is typically different from the uplink interference experienced by the gNB, it is difficult to accurately derive CQI based on uplink channel estimation.

### Coherent Joint Transmission Over Multiple TRPs

Recently, Coherent Joint Transmission (CJT) from multiple Transmission/Reception Points (TRPs) has been proposed in 3GPP as a potential enhancement for NR Release 18. The motivation for this proposal is to exploit CJT from multiple TRPs for MU-MIMO scheduling with null forming between co-scheduled UEs.

### Quasi Co-Location (QCL) and Transmission Configuration Indicator (TCI) States

Several signals can be transmitted from different antenna ports of a same base station antenna. These signals can have the same large-scale properties, such as Doppler shift/spread, average delay spread, and average delay. These antenna ports are then said to be quasi co-located.

If the UE knows that two antenna ports are QCL with respect to a certain parameter (e.g., Doppler spread), the UE can estimate that parameter based on one of the antenna ports and use that estimate when receiving the other antenna port. Typically, the first antenna port is represented by a measurement reference signal (known as source RS) such as a Tracking Reference Signal (TRS), a Synchronization Signal Block (SSB), or a periodic CSI-RS, and the second antenna port is represented by another reference signal (known as target RS) such as a demodulation reference signal (DMRS) or CSI-RS. For instance, if antenna ports A and B are QCL with respect to average delay, the UE can estimate the average delay from the signal received from antenna port A (the source RS) and assume that the signal received from antenna port B (the target RS) has the same average delay. This is useful since the UE can know beforehand the large scale properties of the channel and perform channel estimation according to the large scale channel properties. Information about what QCL assumptions can be made is signaled to the UE from the network through TCI state. In NR, four types of QCL relations between a transmitted source RS and transmitted target RS were defined:
QCL Type A: {Doppler shift, Doppler spread, average delay, delay spread}
QCL Type B: {Doppler shift, Doppler spread}
QCL Type C: {average delay, Doppler shift}
QCL Type D: {Spatial Rx parameter}
   QCL type D is known as spatial QCL. If two transmitted antenna ports are spatially QCL, the UE can use the same Rx beam to receive both. TCI states are used to convey QCL information for the reception of DMRS or CSI-RS. Each TCI state contains one or two QCL types each with an associated source RS.

### SUMMARY

Systems and methods are disclosed that relate to configuring Channel State Information Reference Signal (CSI-RS) for Channel State Information (CSI) feedback associated with downlink transmission from multiple Transmission and Reception Points (TRPs). In one embodiment, a method performed by a User Equipment (UE) for CSI feedback comprises receiving, from a network node, information that explicitly or implicitly indicates, for one or more CSI-RS ports in one or more CSI-RS resources in a CSI-RS resource set: (a) multiple Transmission Configuration Indicator (TCI) states associated to each of the one or more CSI-RS resources, (b) a single TCI state for each of multiple CSI-RS resources in the CSI-RS resource set, wherein the multiple CSI-RS resources are fully overlapping in time and frequency and each of the multiple CSI-RS resources is associated to a different TCI state, or (c) a combination of (a) and (b). The method further comprises, based on the information received from the network node, performing channel measurement based on the one or more CSI-RS ports by: (i) measuring each CSI-RS port that is in a CSI-RS resource that is associated to multiple TCI states using the multiple TCI states associated to the CSI-RS resource; and/or (ii) measuring each CSI-RS port that is in the multiple CSI-RS resources each associated to a different TCI state over the multiple CSI-RS resources using the respective TCI states associated to the multiple CSI-RS resources. The method further comprises determining a channel rank based on the channel measurement, computing a channel quality based on the determined rank and the channel measurement, and sending, to the network node, feedback comprising information that indicates the rank and the channel quality. In this manner, the UE is enabled to attain an accurate Quasi Co-Location (QCL) assumption for CSI-RSs during non-Precoding Matrix Indictor (PMI) based multi-TRP CSI acquisition, which could be useful, for example, during Coherent Joint Transmission (CJT).

In one embodiment, the CSI-RS resource set is a CSI-RS resource set that is configured for non-PMI CSI feedback, wherein each of the one or more CSI-RS ports is associated a data transmission layer.

In one embodiment, the one or more CSI-RS resources are Non-zero Power (NZP) CSI-RS resources for channel measurement.

In one embodiment, the information received from the network node explicitly indicates (a), (b), or (c) for the one or more CSI-RS ports.

In one embodiment, the information received from the network node explicitly indicates the multiple TCI states associated to the one or more CSI-RS resources.

In one embodiment, the information received from the network node that explicitly indicates the multiple TCI states associated to the one or more CSI-RS resources comprises information in a CSI trigger state configured for the CSI feedback that, for each of the one or more CSI-RS resources in the CSI-RS resource set, explicitly indicates that the CSI-RS resource is associated to multiple TCI states.

In another embodiment, the information received from the network node that explicitly indicates the multiple TCI states associated to the one or more CSI-RS resources comprises, for each CSI-RS resource of the one or more CSI-RS resources, information in a CSI-RS resource configuration for the CSI-RS resource that explicitly indicates that the CSI-RS resource is associated to multiple TCI states. In one embodiment, receiving the information comprises receiving the information via Radio Resource Control (RRC) signaling.

In another embodiment, the information received from the network node that explicitly indicates the multiple TCI states associated to the one or more CSI-RS resources comprises information comprised in an NZP-CSI-RS-Resource Information Element (IE) and/or a CSI-ReportConfig IE.

In another embodiment, the one or more CSI-RS resources are semi-persistent CSI-RS resources and the information received from the network node that explicitly indicates the multiple TCI states associated to the one or more CSI-RS resources comprises information comprised in a Medium Access Control (MAC) Control Element (CE) message used to activate and/or deactivate the one or more semi-persistent CSI-RS resources, wherein the information comprised in the MAC CE message comprises a list of TCI states that are to be associated to a respective semi-persistent NZP CSI-RS resource.

In another embodiment, the information received from the network node that explicitly indicates the multiple TCI states associated to the one or more CSI-RS resources comprises a list of TCI states configured to be associated with each of the one or more CSI-RS resources via RRC signaling.

In another embodiment, the information received from the network node that explicitly indicates the multiple TCI states associated to the one or more CSI-RS resources comprises information that explicitly links the set of CSI-RS resources, where each CSI-RS resource in the set of CSI-RS resources is associated with a separate TCI state.

In one embodiment, the information received from the network node implicitly indicates (a), (b), or (c) for the one or more CSI-RS ports.

In one embodiment, the information received from the network node implicitly indicates the multiple TCI states associated to the one or more CSI-RS resources. In one embodiment, the information that implicitly indicates the multiple TCI states associated to the one or more CSI-RS resources comprises information that, for each CSI-RS resource of the one or more CSI-RS resources, implicitly associates the CSI-RS resource to multiple TCI states. In another embodiment, the information that implicitly indicates the multiple TCI states associated to the one or more CSI-RS resources comprises information that implicitly links the set of CSI-RS resources, where each CSI-RS resource in the set of CSI-RS resources is associated with a separate TCI state. In another embodiment, the information that implicitly indicates the multiple TCI states associated to the one or more CSI-RS resources comprises information that implicitly links the set of CSI-RS resources based on how CSI-RS resources in the set are configured. In another embodiment, a unified TCI state framework is configured for the UE and two or more joint/downlink TCI states are indicated, the information that implicitly indicates the multiple TCI states associated to the one or more CSI-RS resources comprises information that associates a CSI-RS resource with a report setting used for the CSI feedback, which implicitly indicates that the CSI-RS resource is QCL with all the indicated joint/downlink TCI states.

Corresponding embodiments of a UE are also disclosed. In one embodiment, a UE for CSI feedback comprises one or more transmitters, one or more receivers, and processing circuitry associated with the one or more transmitters and the one or more receivers. The processing circuitry is configured to cause the UE to receive, from a network node, information that explicitly or implicitly indicates, for one or more CSI-RS ports in one or more CSI-RS resources in a CSI-RS resource set: (a) multiple Transmission Configuration Indicator (TCI) states associated to each of the one or more CSI-RS resources, (b) a single TCI state for each of multiple CSI-RS resources in the CSI-RS resource set, wherein the multiple CSI-RS resources are fully overlapping in time and frequency and each of the multiple CSI-RS resources is associated to a different TCI state, or (c) a combination of (a) and (b). The processing circuitry is further configured to cause the UE to, based on the information received from the network node, perform channel measurement based on the one or more CSI-RS ports by: (i) measuring each CSI-RS port that is in a CSI-RS resource that is associated to multiple TCI states using the multiple TCI states associated to the CSI-RS resource; and/or (ii) measuring each CSI-RS port that is in the multiple CSI-RS resources each associated to a different TCI state over the multiple CSI-RS resources using the respective TCI states associated to the multiple CSI-RS resources. The processing circuitry is further configured to cause the UE to determine a channel rank based on the channel measurement, compute a channel quality based on the determined rank and the channel measurement, and send, to the network node, feedback comprising information that indicates the rank and the channel quality.

Embodiments of a method performed by a network node are also disclosed. In one embodiment, a method performed by a network node comprises sending, to a UE, information that explicitly or implicitly indicates, for one or more CSI-RS ports in one or more CSI-RS resources in a CSI-RS resource set: (a) multiple TCI states associated to each of the one or more CSI-RS resources, (b) a single TCI state for each of multiple CSI-RS resources in the CSI-RS resource set, wherein the multiple CSI-RS resources are fully overlapping in time and frequency and each of the multiple CSI-RS resources is associated to a different TCI state, or (c) a combination of (a) and (b).

Corresponding embodiments of a network node are also disclosed. In one embodiment, a network node comprises processing circuitry configured to cause the network node to send, to a UE, information that explicitly or implicitly indicates, for one or more CSI-RS ports in one or more CSI-RS resources in a CSI-RS resource set: (a) multiple TCI states associated to each of the one or more CSI-RS resources, (b) a single TCI state for each of multiple CSI-RS resources in the CSI-RS resource set, wherein the multiple CSI-RS resources are fully overlapping in time and frequency and each of the multiple CSI-RS resources is associated to a different TCI state, or (c) a combination of (a) and (b).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is an illustration of a spatial multiplexing operation;

FIG. 2 is an illustration of a two-dimensional antenna array of dual-polarized antenna elements (Nₚ=2), with Nₕ=4 horizontal antenna elements and Nᵥ=4 vertical antenna elements;

FIG. 3 shows an example of Channel State Information Reference Signal (RS) Resource Elements (REs) for twelve antenna ports, where one RE per Resource Block (RB) per port is shown;

FIG. 4 illustrates an example of a non-Precoding Matrix Indicator (PMI) scheme supported in 3^{rd} Generation Partnership Project (3GPP) New Radio (NR);

FIG. 5 illustrates a schematic example of how non-PMI Channel State Information (CSI) feedback can be achieved for Coherent Joint Transmission (CJT) over three Transmission and Reception Points (TRPs);

FIG. 6 illustrates an example for associating a CSI-RS resource with multiple Transmission Configuration Indicator (TCI) states in accordance with one embodiment of the present disclosure;

FIG. 7 illustrates one schematic example of using Radio Resource Control (RRC) signaling to associate multiple TCI states to a CSI-RS resource in accordance with one embodiment of the present disclosure;

FIG. 8 illustrates another example embodiment in which multiple separate lists of TCI states are configured in an aperiodic trigger state, where each list of TCI states can be associated with one out of multiple triggered Non-Zero Power (NZP) CSI-RS resources used for channel measurements;

FIG. 9 illustrate the relationship between various configurations in accordance with one embodiment of the present disclosure;

FIG. 10 illustrates one example embodiment related to an implicit indication;

FIG. 11 illustrates the operation of a network node and a User Equipment (UE) where the UE provides CSI feedback based on measurements on CSI-RSs transmitted from multiple TRPs (e.g., during non-PMI based CSI acquisition), in accordance with one embodiment of the present disclosure;

FIG. 12 shows an example of a communication system in which embodiments of the present disclosure may be implemented;

FIG. 13 shows a UE in accordance with some embodiments;

FIG. 14 shows a network node in accordance with some embodiments;

FIG. 15 is a block diagram of a host, which may be an embodiment of the host of FIG. 12, in accordance with various aspects described herein;

FIG. 16 is a block diagram illustrating a virtualization environment in which functions implemented by some embodiments may be virtualized; and

FIG. 17 shows a communication diagram of a host communicating via a network node with a UE over a partially wireless connection in accordance with some embodiments.

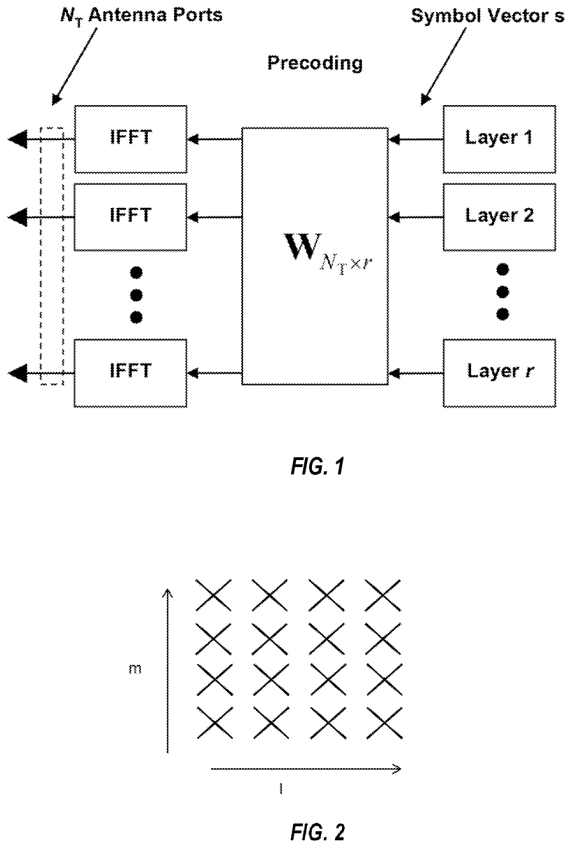

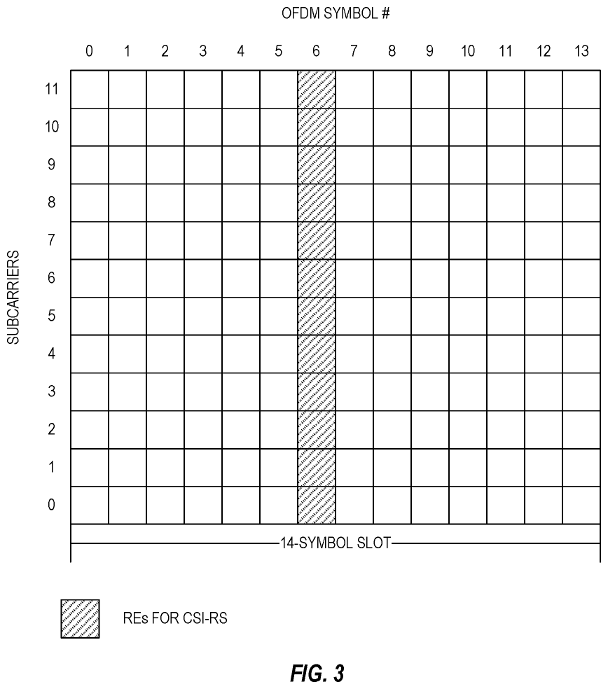

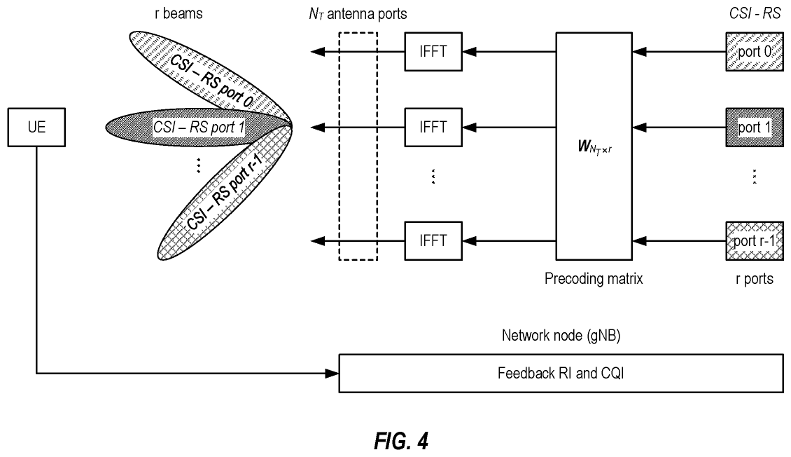

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

There currently exist certain challenge(s). In New Radio (NR), Channel State Information Reference Signal (CSI-RS) in a CSI-RS resource is assumed to be transmitted from a single TRP and thus is configured with a single TCI state. The CSI-RS resource is then used for a UE to measure the downlink (DL) channel associated with the TRP and feedback Channel State Information (CSI) assuming that a PDSCH is to be transmitted from the TRP. In case of coherent joint transmission of a PDSCH over multiple TRPs, how to configure CSI-RS for CSI feedback is an open issue.

Certain aspects of the disclosure and their embodiments may provide solutions to these or other challenges. Embodiments of the present disclosure provide a framework for indicating Quasi Co-Location (QCL) assumptions for CSI-RSs transmitted from multiple TRPs during non-Precoding Matrix Indicator (PMI) based CSI acquisition.

Embodiments of a method performed by a UE for providing CSI feedback are disclosed herein. In one embodiment, a method performed by a UE for providing CSI feedback comprises one or more of the following steps:
The UE receives an indication of QCL assumptions for one or more CSI-RS ports in one or more CSI-RS resources in a CSI-RS resource set, using at least one of the following:
   multiple TCI States associated to the one or more CSI-RS resources (either using explicit or implicit methods detailed below), or
   multiple CSI-RS resources in the CSI-RS resource set each associated with a single TCI state.
The UE performs channel measurement based on the one or more CSI-RS ports using at least one of the following:
   measuring each CSI-RS port using the multiple TCI states associated with the one CSI-RS resource, or
   measuring each CSI-RS port over the multiple CSI-RS resources using the respective TCI states of each of the multiple CSI-RS resources
The UE determines a channel rank based on the channel measurement and computes a channel quality based on the determined rank and the channel measurement.
The UE feeds back (i.e., sends information that indicates) the determined rank and the computed channel quality to the network.

Certain embodiments may provide one or more of the following technical advantage(s). Embodiments of the proposed solution(s) may enable the UE to attain an accurate QCL assumption for CSI-RSs during non-PMI based multi-TRP CSI acquisition, which could be useful, for example, during Coherent Joint Transmission (CJT).

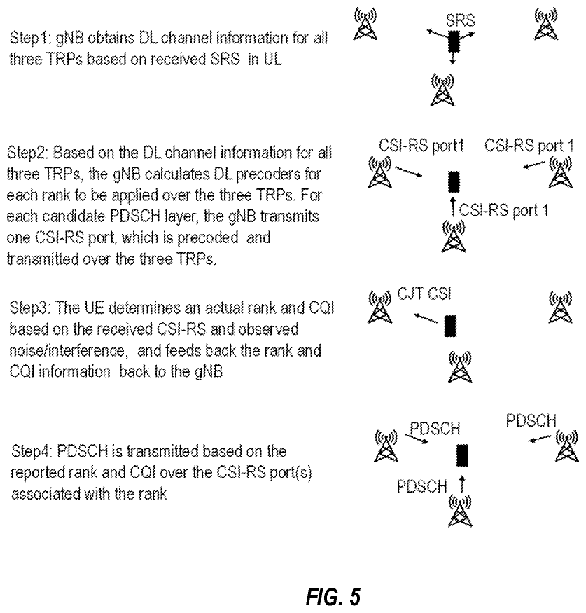

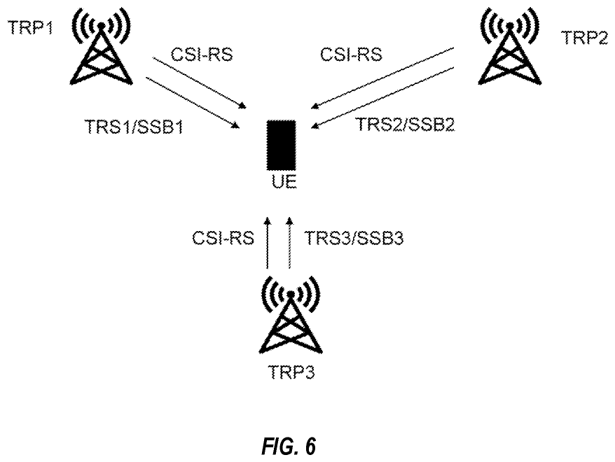

FIG. 5 illustrates a schematic example of how non-PMI CSI feedback can be achieved for CJT over three TRPs. Note that although the example used herein assumes three TRPs, the solutions presented herein are applicable to X number of TRPs, where X is an integer larger than 1.

In Step 1 shown in FIG. 5, the NR base station (gNB) obtains DL channel information of all three TRPs for a UE. The DL channel information may be obtained by the gNB via two approaches. In a first approach, the DL channel information may be obtained by the UE reporting CSI to the gNB (e.g., UE reporting type II CSI feedback to the gNB). In a second approach, the DL channel information is obtained by gNB measurements based on uplink (UL) reference signals if there exists DL and UL channel reciprocity. In this example, the DL channel information is attained from Sounding Reference Signal (SRS) transmissions in the UL.

In Step 2, based on the DL channel information for the three TRPs, the gNB determines precoders to be applied over the three TRPs and uses these precoders to transmit a number of CSI-RS ports, where each CSI-RS port corresponds to one candidate PDSCH layer. One way to determine these precoders is, for example, to first concatenate the channel matrices for all three TRPs to generate one full channel matrix (covering all three TRPs), i.e.,

H=[β₁H₁,β₂H₂,β₃H₃]

where Hᵢ and βᵢ respectively represent a channel matrix and TRP specific scaling coefficient associated with the i^{th} TRP. The gNB can then perform singular value decomposition (SVD) on the full channel matrix H as

H=Σₖ₌₁^{R}σₖuₖvₖ^{H},

where σₖ is the k^{th} (k=1, . . . , R) singular value; uₖ is the k^{th} (k=1, . . . , R) left singular vector; vₖ is the k^{th} (k=1, . . . , R) right singular vector; and, R is the number of layers or rank associated to the channel matrix H. The right singular vector vₖ=[v_{k,1}, v_{k,2}, v_{k,3}]^{T} is the overall precoder for the k^{th} layer (i.e., vₖ is the precoder for the k^{th} layer used over all three TRPs), where v_{k,p} (p=1, 2, 3) is the precoder associated to the p^{th} TRP for the k^{th} layer. The gNB can transmit one CSI-RS port per layer over all three TRPs. The TRP specific scaling coefficient βᵢ is used to take into account possible different automatic gain control (AGC) settings and/or transmit powers among the TRPs.

The gNB may configure the CSI-RS ports in a rank nested manner, in which a same CSI-RS port is shared for different rank assumptions in which case R CSI-RS ports are needed. For example, the singular values can be ordered such that σ₁≥σ₂≥ . . . ≥σ_{R}, and the 1^{st} CSI-RS port is associated with v₁, the 2^{nd} CSI-RS port associated with v₂, and so on. With is arrangement of CSI-RS ports, for rank r (r=1, 2, . . . , R) hypothesis or assumption, the UE measures the channel based on the first r CSI-RS ports. If rank r is determined and reported by the UE to gNB, then gNB would use the first r CSI-RS ports for subsequent DL data transmission.

Alternatively, for each rank assumption, a separate group of CSI-RS ports are configured by the gNB. For example, for rank 1 assumption, the 1^{st} CSI-RS port is used and is associated with v₁; for rank 2 assumption, the 2^{nd} and the 3^{rd} CSI-RS ports are used, and the 2^{nd} CSI-RS port is associated with v₁ and the 3^{rd} CSI-RS port is associated with v₂; for rank r assumption, CSI-RS ports

$$\{ \frac{r ( r - 1 )}{2} + 1 , \frac{r ( r - 1 )}{2} + 2 , … , \frac{r ( r - 1 )}{2} + r \}$$

are used and are associated with precoder {v₁, . . . vᵣ}, respectively.

In Step 3, the UE determines the actual rank and CQI based on the received CSI-RS and interference/noise experienced at the UE and feeds back the actual rank and CQI to the gNB.

In Step 4, the gNB can then apply the feedback for PDSCH transmissions using the reported rank and CQI over the CSI-RS ports associated with the rank.

In this example, each of the CSI-RS ports in one or more CSI-RS resources is transmitted from three different TRPs at possibly different locations and with likely different antenna orientations. Using a single QCL assumption associated with one of the TRPs is not adequate because it would not reflect the large scale channel properties of the composite channel experienced by the CSI-RS.

A number of solutions are proposed herein for associating a CSI-RS resource (and the corresponding CSI-RS ports belonging to that CSI-RS resource) with multiple TCI states. An example is shown FIG. 6, where CSI-RS is transmitted from all three TRPs while a separate Tracking Reference Signal (TRS) and/or Synchronization Signal Block (SSB) is transmitted from each TRP.

Associating a CSI-RS resource to multiple TCI states means that the large scale channel properties of the CSI-RS such as average delay, delay spread, and spatial filter can be inferred from multiple other DL RS contained in the TCI states.

When the UE is measuring a CSI-RS port in a CSI-RS resource associated with multiple TCI states, the UE may perform synchronization and estimation of the long term channel properties using the DL RS (e.g., TRS) in one or more of the associated multiple TCI states. For instance, the UE may obtain multiple channel delay spreads associated with the DL RS in the multiple TCI states. These multiple channel delay spreads may be combined by the UE to obtain a combined channel delay spread. The combined channel delay spread may then be used as input to the channel estimation algorithm when measuring the CSI-RS port in a CSI-RS resource associated with multiple TCI states. This process may be captured in 3GPP specifications as a UE performing measurements on a CSI-RS port in a CSI-RS resource associated with multiple TCI states.

When the UE performs non-PMI CSI feedback for CJT based on a single CSI-RS resource associated with multiple TCI states, for rank r assumption, the UE performs channel measurements on each of the r selected CSI-RS ports using the multiple TCI states associated with the single CSI-RS resource. Note that the r selected CSI-RS ports are in the single or multiple CSI-RS resources. The UE then computes the CQI corresponding to the channel measurements performed on the r selected CSI-RS ports, and also taking into account interference/noise measured on interference measurement resource(s).

Alternatively, instead of using a single or multiple CSI-RS resources each associated with multiple TRPs, non-PMI CSI feedback may also be achieved for CJT based on multiple CSI-RS resources where each CSI-RS resource is associated with a single TRP and thus a single TCI state, and different CSI-RS resources are associated with different TRPs and thus different TCI states. In some embodiments, the multiple CSI-RS resources may be configured on different or overlapping time-frequency resources (i.e., the REs of the multiple CSI-RS resources are completely overlapping). In case of overlapping time-frequency resources, a single CSI-RS port is measured over the multiple CSI-RS resources using the respective TCI states.

### Explicit Association Between Multiple TCI States and a CSI-RS Resource

In this embodiment, each CSI-RS resource in a CSI-RS resource set configured for non-PMI CSI feedback is explicitly associated to multiple TCI states. Each of the multiple TCI states may consist of one or more of the following:
a QCL source reference signal (RS) of QCL Type A, B, or C
a QCL source RS of QCL Type D
   The QCL Type A, B, or C source RSs and/or the QCL Type D source RSs in the multiple TCI states are different and may be transmitted from different TRPs.

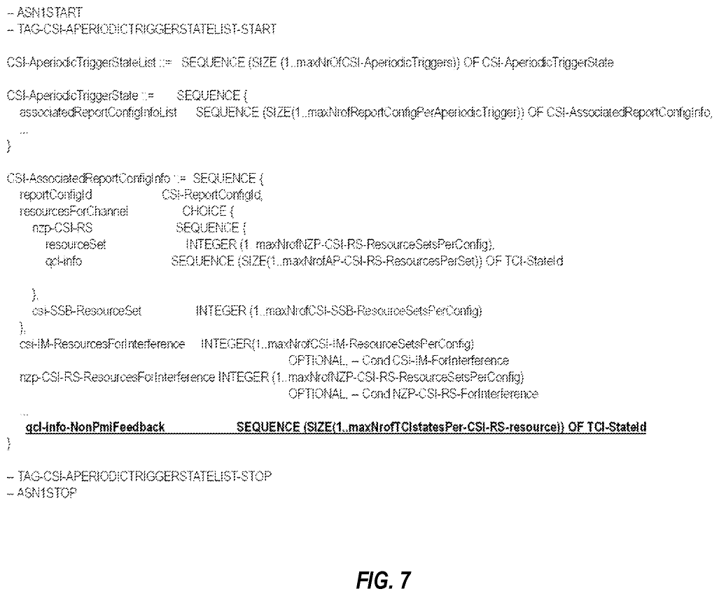

In one variant of this embodiment, for aperiodic CSI-RS resources, Radio Resource Control (RRC) signaling is used to associate multiple TCI states to a CSI-RS resource. One schematic example of this is illustrated in FIG. 7, where a new parameter (here called “qcl-info-NonPmiFeedback”) is introduced in an Aperiodic Trigger State Information Element (IE) (as defined in 3GPP Technical Specification (TS) 38.331), and where several TCI states can be listed. To be specific, “qcl-info-NonPmiFeedback” is configured within the structure ‘CSI-AssociatedReportConfigInfo’ wherein one or more ‘CSI-AssociatedReportConfigInfo’ structures belong to a single CSI-AperiodicTriggerState. For example, assume that three TCI states (TCI state ID 1, TCI state ID 2 & TCI state ID 3) are RRC configured in “qcl-info-NonPmiFeedback” in an aperiodic trigger state, then when a Downlink Control Information (DCI) indicates this aperiodic trigger state and “non-PMI” feedback is indicated in the associated CSI report setting, the UE should assume that all the NZP CSI-RS resources used for channel measurement triggered by the aperiodic trigger state should be QCL with all three TCI states (TCI state ID 1, TCI state ID 2 & TCI state ID 3).

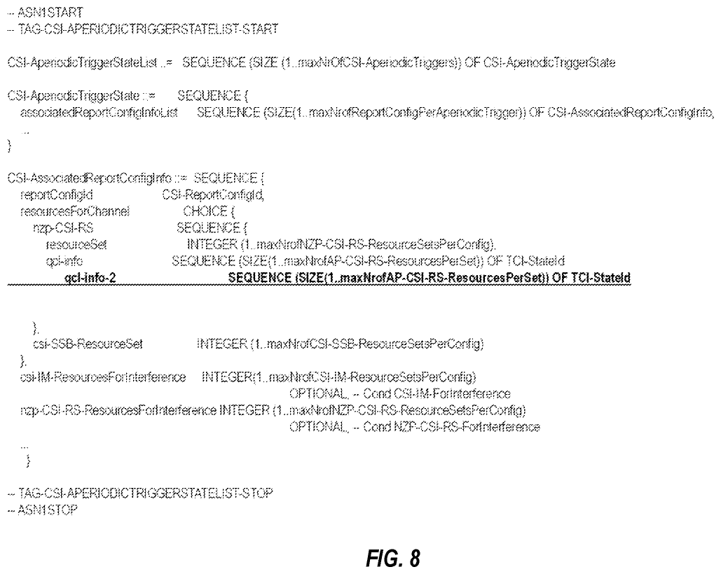

In another variant of this embodiment, multiple separate lists of TCI states are configured in an aperiodic trigger state, where each list of TCI states can be associated with one out of multiple triggered NZP CSI-RS resources used for channel measurements. In this way, different CSI-RS resources can be associated with different groups of TCI states, and hence different groups of TRPs. FIG. 8 shows an example where the multiple lists corresponding to the CSI-RS resources in the resourceSet of a CSI-AssociatedReportConfigInfo. In this example, a first CSI-RS resource in the resourceSet is provided two TCI states where the first TCI state is provided by the 1^{st} TCI-StateId in qcl-info and the second TCI state is provided by the 1^{st} TCI-StateId in qcl-info-2. Similarly, a second CSI-RS resource in the resourceSet is provided two TCI states where the first TCI state is provided by the 2^{nd} TCI-StateId in qcl-info and the second TCI state is provided by the 2nd TCI-StateId in qcl-info-2.

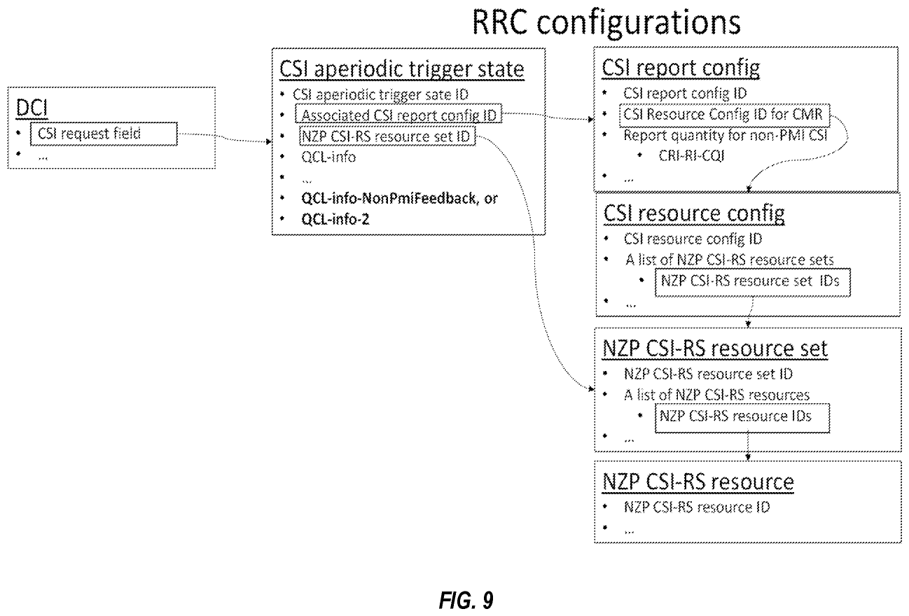

FIG. 9 illustrate the relationship between the various configurations.

In another variant of the embodiment, the RRC signaling associating multiple TCI states with a CSI-RS resource is configured by introducing a new parameter (for example “qcl-info-NonPmiFeedback”) in NZP-CSI-RS-Resource IE, NZP-CSI-RS-ResourceSet IE, and/or CSI-ReportConfig IE as defined in 3GPP TS 38.331.

In another embodiment, the Medium Access Control (MAC) Control Element (CE), MAC-CE, message used to activate and/or de-activate a semi-persistent CSI-RS resource includes a list of TCI states that should be associate to the semi-persistent NZP CSI-RS resource. When the UE receives the semi-persistent NZP CSI-RS resource, it should assume that the semi-persistent NZP CSI-RS resource is QCL with all the listed TCI states indicated in that MAC-CE.

In another embodiment, a list of TCI states may be configured to be associated with a CSI-RS resource via RRC signaling. Then, a MAC-CE message is used to activate and/or de-activate one or more of the TCI states in the configured list of TCI states.

In another embodiment, there is an explicit link between a set of CSI-RS resources, where each of the CSI-RS resources in the set of CSI-RS resources is associated with a separate TCI state. The UE should then assume that each CSI-RS resource in the set of CSI-RS resources is QCL with all the TCI states associated with any of the CSI-RS resources in the set of CSI-RS resources. For example, assume that we have three CSI-RS resources (CSI-RS resource 1, CSI-RS resource 2 & CSI-RS resource 3) that are explicitly linked together (for example by configuring an explicit new parameter in respective NZP-CSI-RS-Resource IE as specified in TS 38.331), and that each of these three CSI-RS resources are associated with a unique TCI state (e.g., TCI state 1, TCI state 2 & TCI state 3, respectively). Then, the UE should assume that each of the three CSI-RS resources is QCL with all three TCI states (TCI state 1, TCI state 2 & TCI state 3). The explicit association between CSI-RS resource can for example be RRC configured with a new parameter in respective NZP-CSI-RS-Resource IE, or in an NZP-CSI-RS-Resource-Set IE as specified in TS 38.331.

### Implicit Association Between Multiple TCI States and a CSI-RS Resource

In this embodiment, a CSI-RS resource is implicitly associated to multiple TCI states. The different TCI states may consist of one or more of the following:
different QCL source reference signals (RSs) of QCL Types A, B, or C, where the different QCL Type A/B/C source RSs may be transmitted from different TRPs
different QCL source RSs of QCL Type D, where the different QCL Type D source RSs may be transmitted from different TRPs

In one embodiment, there is an implicit link between a set of CSI-RS resources, where each of the CSI-RS resources in the set of CSI-RS resources is configured or associated with one TCI state. The UE should assume that each CSI-RS resource in the set of CSI-RS resources is QCL with all the TCI states associated with all the CSI-RS resources in the set of CSI-RS resources. For example, assume that we have three CSI-RS resources (CSI-RS resource 1, CSI-RS resource 2 & CSI-RS resource 3) that are implicitly linked together, (some examples of how to implicitly association for CSI-RS resources are given in next paragraph) and that each of these three CSI-RS resources are associated with a unique TCI state (TCI state 1, TCI state 2 & TCI state 3, respectively). Then, the UE should assume that each of the three CSI-RS resources is QCL with all three TCI states (TCI state 1, TCI state 2 & TCI state 3).

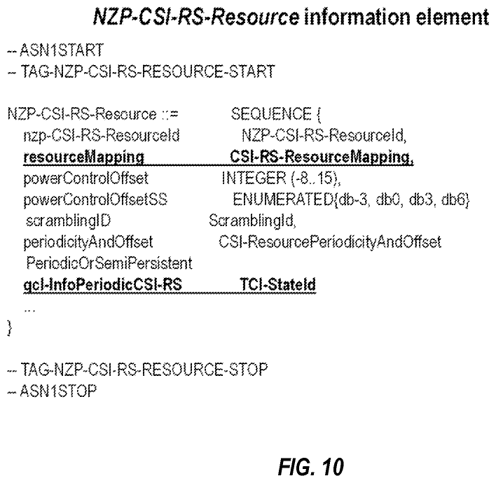

In another embodiment, the implicit link between CSI-RS resources is based on how the CSI-RS resources are configured. For example, CSI-RS resources in a CSI-RS resource set are linked if they have identical configurations for all or a subset of parameters. In one variant of this embodiment, the implicitly linked CSI-RS resources must be included in the same CSI-RS resource set as well. In yet another embodiment, the CSI-RS resources implicitly linked together must be associated with a report setting used for non-PMI feedback. Some parameters that need to be identical can for example be “resourceMapping” (as highlighted in bold, underlined text in FIG. 10), scrambling ID, periodicity AndOffset etc. configured in NZP-CSI-RS-Resource IE as specified in TS 38.331.

In one alternate of this embodiment, in case the unified TCI state framework is configured for a UE and where two or more Joint/DL TCI states are applied, the UE should implicitly assume that a CSI-RS resource associated with a report setting used for non-PMI CSI feedback, is QCL with all the applied Joint/DL TCI states.

### CSI Feedback Procedure

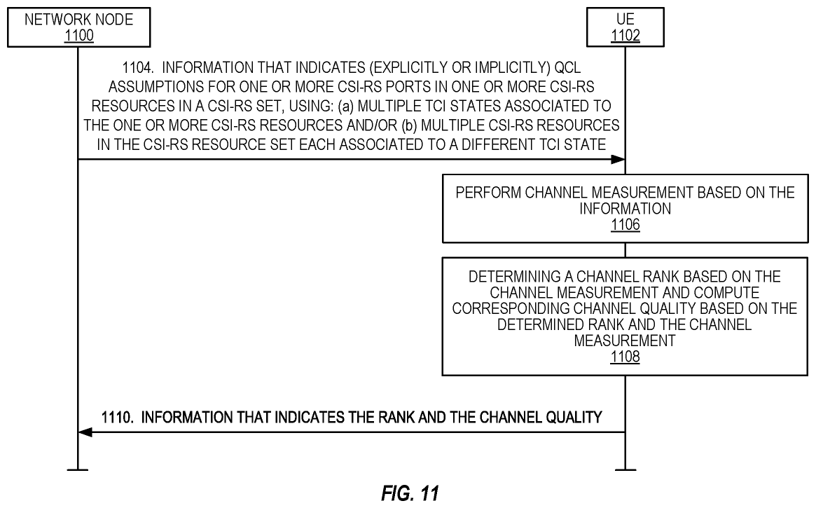

FIG. 11 illustrates the operation of a network node 1100 and a UE 1102 where the UE 1102 provides CSI feedback based on measurements on CSI-RSs transmitted from multiple TRPs (e.g., during non-PMI based CSI acquisition), in accordance with one embodiment of the present disclosure. As illustrated, the network node 1100 sends, to the UE 1102, information that explicitly or implicitly indicates QCL assumptions for one or more CSI-RS ports in one or more CSI-RS resources in a CSI-RS resource set using: (a) multiple TCI states associated with the one or more CSI-RS resources, (b) multiple CSI-RS resources in the CSI-RS resource set each associated with a different TCI state, or both (a) and (b) (step 1104). Embodiments related to this explicit or implicit indication are described above and are applicable here.

The UE 1102 receives the explicit or implicit indication of step 1104 and performs channel measurement based on the one or more CSI-RS ports by: (i) measuring each CSI-RS port (e.g., each CSI-RS port that is in a CSI-RS resource that is associated to multiple TCI states) using the multiple TCI states associated with the (respective) CSI-RS resource, (ii) measuring each CSI-RS port (e.g., each CSI-RS port that is in multiple CSI-RS resources each associated to a different TCI state) over the multiple CSI-RS resources using the respective TCI states of the multiple CSI-RS resources, or (c) a combination of (a) and (b) (step 1106).

The UE 1102 determines a channel rank based on the channel measurement and computes a channel quality based on the determined rank and the channel measurement (step 1108). The UE 1102 then sends feedback to the network node 1100 including the determined rank and the computed channel quality (step 1110).

### Example System in which Embodiments of the Present Disclosure May be Implemented

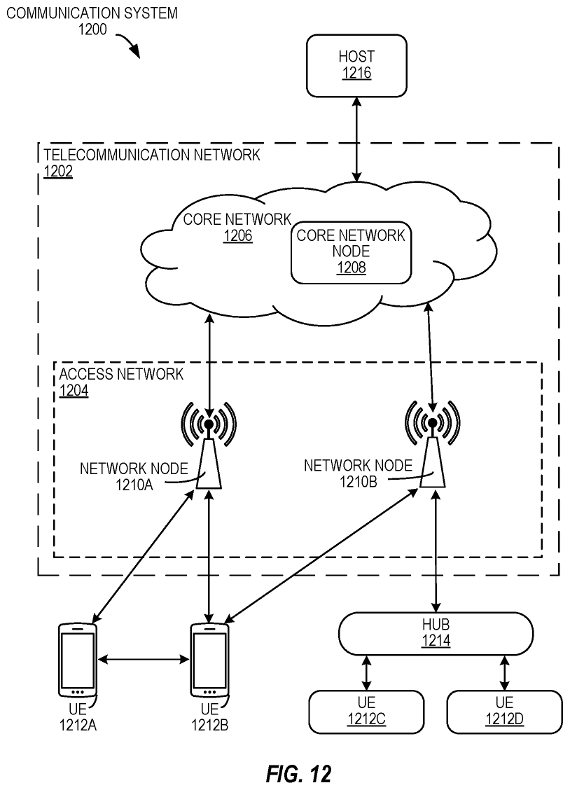

FIG. 12 shows an example of a communication system 1200 in which embodiments of the present disclosure may be implemented.

In the example, the communication system 1200 includes a telecommunication network 1202 that includes an access network 1204, such as a Radio Access Network (RAN), and a core network 1206, which includes one or more core network nodes 1208. The access network 1204 includes one or more access network nodes, such as network nodes 1210A and 1210B (one or more of which may be generally referred to as network nodes 1210), or any other similar Third Generation Partnership Project (3GPP) access node or non-3GPP Access Point (AP). The network nodes 1210 facilitate direct or indirect connection of User Equipment (UE), such as by connecting UEs 1212A, 1212B, 1212C, and 1212D (one or more of which may be generally referred to as UEs 1212) to the core network 1206 over one or more wireless connections. Note that the network node 1100 of FIG. 11 may be, for example, one of the network nodes 1210, and the UE 1102 of FIG. 11 may be one of the UEs 1212.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system 1200 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1202 is a cellular network that implements 3GPP standardized features. Accordingly, the telecommunication network 1202 may support network slicing to provide different logical networks to different devices that are connected to the telecommunication network 1202. For example, the telecommunication network 1202 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1214 communicates with the access network 1204 to facilitate indirect communication between one or more UEs (e.g., UE 1212C and/or 1212D) and network nodes (e.g., network node 1210B). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a Virtual Reality (VR) headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210B. The hub 1214 may also allow for a different communication scheme and/or schedule between the hub 1214 and UEs (e.g., UE 1212C and/or 1212D), and between the hub 1214 and the core network 1206. In other examples, the hub 1214 is connected to the core network 1206 and/or one or more UEs via a wired connection. Moreover, the hub 1214 may be configured to connect to a Machine-to-Machine (M2M) service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210B. In other embodiments, the hub 1214 may be a non-dedicated hub—that is, a device which is capable of operating to route communications between the UEs and the network node 1210B, but which is additionally capable of operating as a communication start and/or end point for certain data channels.

FIG. 13 shows a UE 1300 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1302 may include multiple Central Processing Units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging the power source 1308. Power circuitry may perform any formatting, converting, or other modification to the power from the power source 1308 to make the power suitable for the respective components of the UE 1300 to which power is supplied.

The memory 1310 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1310 may allow the UE 1300 to access instructions, application programs, and the like stored on transitory or non-transitory memory media, to off-load data, or to upload data. An article of manufacture, such as one utilizing a communication system, may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., the antenna 1322) and may share circuit components, software, or firmware, or alternatively be implemented separately.

In the illustrated embodiment, communication functions of the communication interface 1312 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1312, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

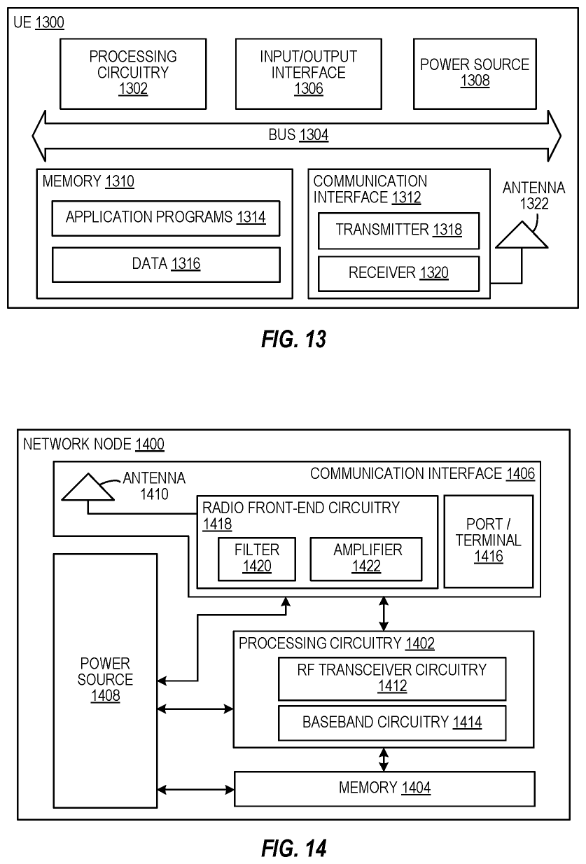

FIG. 14 shows a network node 1400 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes processing circuitry 1402, memory 1404, a communication interface 1406, and a power source 1408. The network node 1400 may be composed of multiple physically separate components (e.g., a Node B component and an RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1400 may be configured to support multiple RATs. In such embodiments, some components may be duplicated (e.g., separate memory 1404 for different RATs) and some components may be reused (e.g., an antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1400.

The processing circuitry 1402 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1400 components, such as the memory 1404, to provide network node 1400 functionality.

In some embodiments, the processing circuitry 1402 includes a System on a Chip (SOC). In some embodiments, the processing circuitry 1402 includes one or more of Radio Frequency (RF) transceiver circuitry 1412 and baseband processing circuitry 1414. In some embodiments, the RF transceiver circuitry 1412 and the baseband processing circuitry 1414 may be on separate chips (or sets of chips), boards, or units, such as radio units and digital units. In alternative embodiments, part or all of the RF transceiver circuitry 1412 and the baseband processing circuitry 1414 may be on the same chip or set of chips, boards, or units.

The memory 1404 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and the memory 1404 are integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. The radio front-end circuitry 1418 comprises filters 1420 and amplifiers 1422. The radio front-end circuitry 1418 may be connected to the antenna 1410 and the processing circuitry 1402. The radio front-end circuitry 1418 may be configured to condition signals communicated between the antenna 1410 and the processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of the filters 1420 and/or the amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface 1406 may comprise different components and/or different combinations of components.

In certain alternative embodiments, the network node 1400 does not include separate radio front-end circuitry 1418; instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes the one or more ports or terminals 1416, the radio front-end circuitry 1418, and the RF transceiver circuitry 1412 as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, the communication interface 1406, and/or the processing circuitry 1402 may be configured to perform any receiving operations and/or certain obtaining operations described herein as being performed by the network node 1400. Any information, data, and/or signals may be received from a UE, another network node, and/or any other network equipment. Similarly, the antenna 1410, the communication interface 1406, and/or the processing circuitry 1402 may be configured to perform any transmitting operations described herein as being performed by the network node 1400. Any information, data, and/or signals may be transmitted to a UE, another network node, and/or any other network equipment.

The power source 1408 provides power to the various components of the network node 1400 in a form suitable for the respective components (e.g., at a voltage and current level needed for each respective component). The power source 1408 may further comprise, or be coupled to, power management circuitry to supply the components of the network node 1400 with power for performing the functionality described herein. For example, the network node 1400 may be connectable to an external power source (e.g., the power grid or an electricity outlet) via input circuitry or an interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

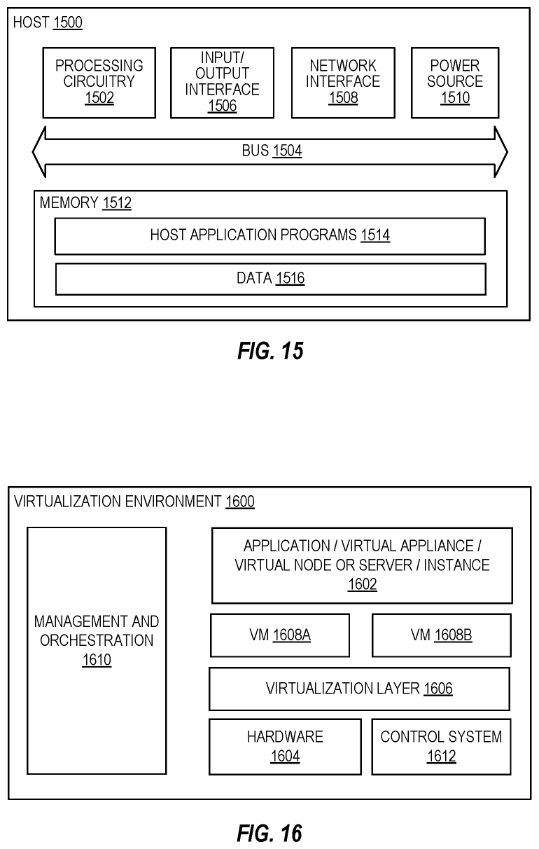

FIG. 15 is a block diagram of a host 1500, which may be an embodiment of the host 1216 of FIG. 12, in accordance with various aspects described herein. As used herein, the host 1500 may be or comprise various combinations of hardware and/or software including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and memory 1512. Other components may be included in other embodiments. Features of these components may be substantially similar to those described with respect to the devices of previous figures, such as FIGS. 13 and 14, such that the descriptions thereof are generally applicable to the corresponding components of the host 1500.

The memory 1512 may include one or more computer programs including one or more host application programs 1514 and data 1516, which may include user data, e.g. data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for Over-The-Top (OTT) services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or VM Monitors (VMMs)), provide VMs 1608A and 1608B (one or more of which may be generally referred to as VMs 1608), and/or perform any of the functions, features, and/or benefits described in relation with some embodiments described herein. The virtualization layer 1606 may present a virtual operating platform that appears like networking hardware to the VMs 1608.

The VMs 1608 comprise virtual processing, virtual memory, virtual networking, or interface and virtual storage, and may be run by a corresponding virtualization layer 1606. Different embodiments of the instance of a virtual appliance 1602 may be implemented on one or more of the VMs 1608, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1608 may be a software implementation of a physical machine that runs programs as if they were executing on a physical, non-virtualized machine. Each of the VMs 1608, and that part of the hardware 1604 that executes that VM, be it hardware dedicated to that VM and/or hardware shared by that VM with others of the VMs 1608, forms separate virtual network elements. Still in the context of NFV, a virtual network function is responsible for handling specific network functions that run in one or more VMs 1608 on top of the hardware 1604 and corresponds to the application 1602.

The hardware 1604 may be implemented in a standalone network node with generic or specific components. The hardware 1604 may implement some functions via virtualization. Alternatively, the hardware 1604 may be part of a larger cluster of hardware (e.g., such as in a data center or CPE) where many hardware nodes work together and are managed via management and orchestration 1610, which, among others, oversees lifecycle management of the applications 1602. In some embodiments, the hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1612 which may alternatively be used for communication between hardware nodes and radio units.

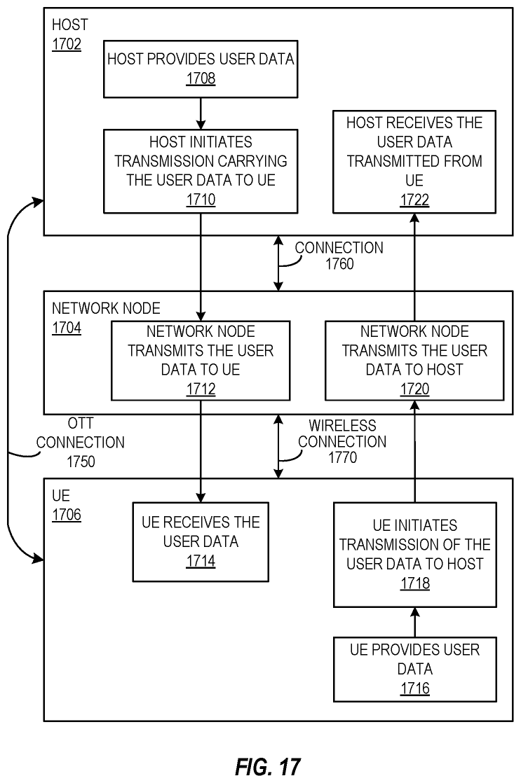

FIG. 17 shows a communication diagram of a host 1702 communicating via a network node 1704 with a UE 1706 over a partially wireless connection in accordance with some embodiments. Example implementations, in accordance with various embodiments, of the UE (such as the UE 1212A of FIG. 12 and/or the UE 1300 of FIG. 13), the network node (such as the network node 1210A of FIG. 12 and/or the network node 1400 of FIG. 14), and the host (such as the host 1216 of FIG. 12 and/or the host 1500 of FIG. 15) discussed in the preceding paragraphs will now be described with reference to FIG. 17.

Like the host 1500, embodiments of the host 1702 include hardware, such as a communication interface, processing circuitry, and memory. The host 1702 also includes software, which is stored in or is accessible by the host 1702 and executable by the processing circuitry. The software includes a host application that may be operable to provide a service to a remote user, such as the UE 1706 connecting via an OTT connection 1750 extending between the UE 1706 and the host 1702. In providing the service to the remote user, a host application may provide user data which is transmitted using the OTT connection 1750.

The network node 1704 includes hardware enabling it to communicate with the host 1702 and the UE 1706 via a connection 1760. The connection 1760 may be direct or pass through a core network (like the core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by the UE 1706 and executable by the UE's processing circuitry. The software includes a client application, such as a web browser or operator-specific “app” that may be operable to provide a service to a human or non-human user via the UE 1706 with the support of the host 1702. In the host 1702, an executing host application may communicate with the executing client application via the OTT connection 1750 terminating at the UE 1706 and the host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via the connection 1760 between the host 1702 and the network node 1704 and via a wireless connection 1770 between the network node 1704 and the UE 1706 to provide the connection between the host 1702 and the UE 1706. The connection 1760 and the wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704 in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR, or AR which it can broadcast, multicast, or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1750 between the host 1702 and the UE 1706 in response to variations in the measurement results. The measurement procedure and/or the network functionality for reconfiguring the OTT connection 1750 may be implemented in software and hardware of the host 1702 and/or the UE 1706. In some embodiments, sensors (not shown) may be deployed in or in association with other devices through which the OTT connection 1750 passes; the sensors may participate in the measurement procedure by supplying values of the monitored quantities exemplified above, or by supplying values of other physical quantities from which software may compute or estimate the monitored quantities. The reconfiguring of the OTT connection 1750 may include message format, retransmission settings, preferred routing, etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency, and the like by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment, UE, (1102) for Channel State Information, CSI, feedback, the method comprising one or more of the following steps:
receiving (1104), from a network node (1100), information that explicitly or implicitly indicates Quasi Co-Location, QCL, assumptions for one or more CSI Reference Signal, CSI-RS, ports in one or more CSI-RS resources in a CSI-RS resource set, using:
   (a) multiple Transmission Configuration Indication, TCI, states associated to the one or more CSI-RS resources,
   (b) multiple CSI-RS resources in the CSI-RS resource set each associated to a different TCI state; or
   (c) a combination of (a) and (b);
based on the information that explicitly or implicitly indicates the QCL assumptions for the one or more CSI-RS ports, performing (1106) channel measurement based on the one or more CSI-RS ports by:
   (i) measuring each CSI-RS port (e.g., each CSI-RS port that is in a CSI-RS resource that is associated to multiple TCI states) using the multiple TCI states associated with the CSI-RS resource; and/or
   (ii) measuring each CSI-RS port (e.g., each CSI-RS port that is in multiple CSI-RS resources each associated to a different TCI state) over the multiple CSI-RS resources using the respective TCI states of the multiple CSI-RS resources;
determining (1108) a channel rank based on the channel measurement;
computing (1108) a channel quality based on the determined rank and the channel measurement; and
sending (1110), to the network node (1100), feedback comprising information that indicates the rank and the channel quality.

Embodiment 2: The method of embodiment 1 wherein one or more CSI-RS resources are Non-zero Power, NZP, CSI-RS resources for channel measurement.

Embodiment 3: The method of embodiment 1 or 2 wherein the information explicitly indicates QCL assumptions for the one or more CSI-RS ports.

Embodiment 4: The method of embodiment 3 wherein the information that explicitly indicates QCL assumptions for the one or more CSI-RS ports comprises information that, for each of the one or more CSI-RS resources in the CSI-RS resource set, explicitly indicates in a CSI trigger state configured for the CSI feedback that the CSI-RS resource is associated to multiple TCI states, wherein the CSI trigger state comprises indices of the one or more CSI-RS resources.

Embodiment 5: The method of embodiment 3 wherein the information that explicitly indicates QCL assumptions for the one or more CSI-RS ports comprises information that, for each of the one or more CSI-RS resources, explicitly indicates in a CSI-RS resource configuration for the CSI-RS resource that the CSI-RS resource is associated to multiple TCI states.

Embodiment 6: The method of embodiment 5 wherein receiving (1104) the information comprises receiving (1104) the information via RRC signaling.

Embodiment 7: The method of embodiment 6 wherein the information is comprised in an aperiodic CSI trigger state information element, IE.

Embodiment 8: The method of any of embodiments 3 to 7 wherein the information that explicitly indicates QCL assumptions for the one or more CSI-RS ports in the one or more CSI-RS resources comprises multiple separate lists of TCI states configured in an aperiodic trigger state configured for the CSI feedback, where each list of TCI states is associated with one out of the one or more CSI-RS resources.

Embodiment 9: The method of embodiment 4 wherein the information that explicitly indicates QCL assumptions for the one or more CSI-RS ports comprises information comprised in an NZP-CSI-RS-Resource IE and/or a CSI-ReportConfig IE.

Embodiment 10: The method of embodiment 3 wherein the one or more CSI-RS resources are semi-persistent CSI-RS resources and the information that explicitly indicates QCL assumptions for the one or more CSI-RS ports in the one or more CSI-RS resources comprises information comprised in a Medium Access Control, MAC, Control Element, CE, message used to activate and/or deactivate the one or more semi-persistent CSI-RS resources, wherein the information comprised in the MAC CE message comprises a list of TCI states that are to be associated to a respective semi-persistent NZP CSI-RS resource.

Embodiment 11: The method of embodiment 3 wherein the information that explicitly indicates QCL assumptions for the one or more CSI-RS ports comprises a list of TCI states configured to be associated with each of the one or more CSI-RS resources via RRC signaling.

Embodiment 12: The method of embodiment 3 wherein the information that explicitly indicates QCL assumptions for the one or more CSI-RS ports in the one or more CSI-RS resources in a CSI-RS resource set comprises information that explicitly links the set of CSI-RS resources, where each CSI-RS resource in the set of CSI-RS resources is associated with a separate TCI state.

Embodiment 13: The method of embodiment 1 or 2 wherein the information implicitly indicates QCL assumptions for the one or more CSI-RS ports.

Embodiment 14: The method of embodiment 13 wherein the information that implicitly indicates QCL assumptions for the one or more CSI-RS ports in one or more CSI-RS resources comprises information that, for each of the one or more CSI-RS resources, implicitly associates the CSI-RS resource to multiple TCI states.

Embodiment 15: The method of embodiment 13 wherein the information comprises information that implicitly links a set of CSI-RS resources, where each CSI-RS resource in the set of CSI-RS resources is associated with a separate TCI state.

Embodiment 16: The method of embodiment 13 wherein the information comprises information that implicitly links a set of CSI-RS resources based on how CSI-RS resources in the set are configured.

Embodiment 17: The method of embodiment 13 wherein a unified TCI state framework is configured for the UE (1102) and two or more joint/downlink TCI states are indicated, the information that implicitly indicates QCL assumptions for the one or more CSI-RSs comprises information that associates a CSI-RS resource with a report setting used for the CSI feedback, which implicitly indicates that the CSI-RS resource is QCL with all the indicated joint/downlink TCI states.

Embodiment 18: The method of any of the previous embodiments, further comprising: providing user data; and forwarding the user data to a host via the transmission to the network node.

### Group B Embodiments

Embodiment 19: A method performed by a network node (1100), the method comprising:
sending (1104), to a user equipment, UE, (1102), information that explicitly or implicitly indicates Quasi Co-Location, QCL, assumptions for one or more CSI Reference Signal, CSI-RS, ports in one or more CSI-RS resources in a CSI-RS resource set, using:
   (a) multiple Transmission Configuration Indication, TCI, states associated to the one or more CSI-RS resources,
   (b) multiple CSI-RS resources in the CSI-RS resource set each associated to a different TCI state; or
   (c) a combination of (a) and (b).

Embodiment 20: The method of embodiment 19 wherein one or more CSI-RS resources are Non-zero Power, NZP, CSI-RS resources for channel measurement.

Embodiment 21: The method of embodiment 19 or 20 wherein the information explicitly indicates QCL assumptions for the one or more CSI-RS ports.

Embodiment 22: The method of embodiment 21 wherein the information that explicitly indicates QCL assumptions for the one or more CSI-RS ports comprises information that, for each of the one or more CSI-RS resources in the CSI-RS resource set, explicitly indicates in a CSI trigger state configured for the CSI feedback that the CSI-RS resource is associated to multiple TCI states, wherein the CSI trigger state comprises indices of the one or more CSI-RS resources.

Embodiment 23: The method of embodiment 21 wherein the information that explicitly indicates QCL assumptions for the one or more CSI-RS ports comprises information that, for each of the one or more CSI-RS resources, explicitly indicates in a CSI-RS resource configuration for the CSI-RS resource that the CSI-RS resource is associated to multiple TCI states.

Embodiment 24: The method of embodiment 23 wherein sending (1104) the information comprises sending (1104) the information via RRC signaling.

Embodiment 25: The method of embodiment 24 wherein the information is comprised in an aperiodic CSI trigger state information element, IE.

Embodiment 26: The method of any of embodiments 21 to 25 wherein the information that explicitly indicates QCL assumptions for the one or more CSI-RS ports in the one or more CSI-RS resources comprises multiple separate lists of TCI states configured in an aperiodic trigger state configured for the CSI feedback, where each list of TCI states is associated with one out of the one or more CSI-RS resources.

Embodiment 27: The method of embodiment 21 wherein the information that explicitly indicates QCL assumptions for the one or more CSI-RS ports comprises information comprised in an NZP-CSI-RS-Resource IE and/or a CSI-ReportConfig 1E.

Embodiment 28: The method of embodiment 21 wherein the one or more CSI-RS resources are semi-persistent CSI-RS resources and the information that explicitly indicates QCL assumptions for the one or more CSI-RS ports in the one or more CSI-RS resources comprises information comprised in a Medium Access Control, MAC, Control Element, CE, message used to activate and/or deactivate the one or more semi-persistent CSI-RS resources, wherein the information comprised in the MAC CE message comprises a list of TCI states that are to be associated to a respective semi-persistent NZP CSI-RS resource.

Embodiment 29: The method of embodiment 21 wherein the information that explicitly indicates QCL assumptions for the one or more CSI-RS ports comprises a list of TCI states configured to be associated with each of the one or more CSI-RS resources via RRC signaling.

Embodiment 30: The method of embodiment 21 wherein the information that explicitly indicates QCL assumptions for the one or more CSI-RS ports in the one or more CSI-RS resources in a CSI-RS resource set comprises information that explicitly links the set of CSI-RS resources, where each CSI-RS resource in the set of CSI-RS resources is associated with a separate TCI state.

Embodiment 31: The method of embodiment 19 or 20 wherein the information implicitly indicates QCL assumptions for the one or more CSI-RS ports.

Embodiment 32: The method of embodiment 31 wherein the information that implicitly indicates QCL assumptions for the one or more CSI-RS ports in one or more CSI-RS resources comprises information that, for each of the one or more CSI-RS resources, implicitly associates the CSI-RS resource to multiple TCI states.

Embodiment 33: The method of embodiment 31 wherein the information comprises information that implicitly links a set of CSI-RS resources, where each CSI-RS resource in the set of CSI-RS resources is associated with a separate TCI state.

Embodiment 34: The method of embodiment 31 wherein the information comprises information that implicitly links a set of CSI-RS resources based on how CSI-RS resources in the set are configured.

Embodiment 35: The method of embodiment 31 wherein a unified TCI state framework is configured for the UE (1102) and two or more joint/downlink TCI states are indicated, the information that implicitly indicates QCL assumptions for the one or more CSI-RSs comprises information that associates a CSI-RS resource with a report setting used for CSI feedback, which implicitly indicates that the CSI-RS resource is QCL with all the indicated joint/downlink TCI states.

Embodiment 36: The method of any of the previous embodiments, further comprising: obtaining user data; and forwarding the user data to a host or a user equipment.

### Group C Embodiments

Embodiment 37: A user equipment, comprising: processing circuitry configured to perform any of the steps of any of the Group A embodiments; and power supply circuitry configured to supply power to the processing circuitry.

Embodiment 38: A network node, the network node comprising: processing circuitry configured to perform any of the steps of any of the Group B embodiments; power supply circuitry configured to supply power to the processing circuitry.

Embodiment 39: A user equipment (UE), the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 40: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 41: The host of the previous embodiment, wherein the cellular network further includes a network node configured to communicate with the UE to transmit the user data to the UE from the host.

Embodiment 42: The host of the previous 2 embodiments, wherein: the processing circuitry of the host is configured to execute a host application, thereby providing the user data; and the host application is configured to interact with a client application executing on the UE, the client application being associated with the host application.

Embodiment 43: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 44: The method of the previous embodiment, further comprising: at the host, executing a host application associated with a client application executing on the UE to receive the user data from the UE.

Embodiment 45: The method of the previous embodiment, further comprising: at the host, transmitting input data to the client application executing on the UE, the input data being provided by executing the host application, wherein the user data is provided by the client application in response to the input data from the host application.

Embodiment 46: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 47: The host of the previous embodiment, wherein the cellular network further includes a network node configured to communicate with the UE to transmit the user data from the UE to the host.

Embodiment 48: The host of the previous 2 embodiments, wherein: the processing circuitry of the host is configured to execute a host application, thereby providing the user data; and the host application is configured to interact with a client application executing on the UE, the client application being associated with the host application.

Embodiment 49: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 50: The method of the previous embodiment, further comprising: at the host, executing a host application associated with a client application executing on the UE to receive the user data from the UE.

Embodiment 51: The method of the previous embodiment, further comprising: at the host, transmitting input data to the client application executing on the UE, the input data being provided by executing the host application, wherein the user data is provided by the client application in response to the input data from the host application.

Embodiment 52: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 53: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 54: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 55: The method of the previous embodiment, further comprising, at the network node, transmitting the user data provided by the host for the UE.

Embodiment 56: The method of any of the previous 2 embodiments, wherein the user data is provided at the host by executing a host application that interacts with a client application executing on the UE, the client application being associated with the host application.

Embodiment 57: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 58: The communication system of the previous embodiment, further comprising: the network node; and/or the user equipment.

Embodiment 59: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 60: The host of the previous 2 embodiments, wherein: the processing circuitry of the host is configured to execute a host application, thereby providing the user data; and the host application is configured to interact with a client application executing on the UE, the client application being associated with the host application.

Embodiment 61: The host of the any of the previous 2 embodiments, wherein the initiating receipt of the user data comprises requesting the user data.

Embodiment 62: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 63: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment, UE, for Channel State Information, CSI, feedback, the method comprising:
receiving, from a network node, information that explicitly or implicitly indicates, for one or more CSI Reference Signal, CSI-RS, ports in one or more CSI-RS resources in a CSI-RS resource set:
(a) multiple Transmission Configuration Indicator, TCI, states associated to each of the one or more CSI-RS resources,
(b) a single TCI state for each of multiple CSI-RS resources in the CSI-RS resource set, wherein the multiple CSI-RS resources are fully overlapping in time and frequency and each of the multiple CSI-RS resources is associated to a different TCI state; or
(c) a combination of (a) and (b);
based on the information received from the network node, performing channel measurement based on the one or more CSI-RS ports by:
(i) measuring each CSI-RS port that is in a CSI-RS resource that is associated to multiple TCI states using the multiple TCI states associated to the CSI-RS resource; and/or
(ii) measuring each CSI-RS port that is in the multiple CSI-RS resources each associated to a different TCI state over the multiple CSI-RS resources using the respective TCI states associated to the multiple CSI-RS resources;
determining a channel rank based on the channel measurement;
computing a channel quality based on the determined rank and the channel measurement; and
sending, to the network node, feedback comprising information that indicates the rank and the channel quality.

2. The method of claim 1 wherein the CSI-RS resource set is a CSI-RS resource set that is configured for non-Precoding Matrix Indicator, PMI, CSI feedback, wherein each of the one or more CSI-RS ports is associated a data transmission layer.

3. The method of claim 1 wherein the one or more CSI-RS resources are Non-zero Power, NZP, CSI-RS resources for channel measurement.

4. The method of claim 1 wherein the information received from the network node explicitly indicates (a), (b), or (c) for the one or more CSI-RS ports.

5. The method of claim 1 wherein the information received from the network node explicitly indicates the multiple TCI states associated to the one or more CSI-RS resources.

6. The method of claim 5 wherein the information received from the network node that explicitly indicates the multiple TCI states associated to the one or more CSI-RS resources comprises information in a CSI trigger state configured for the CSI feedback that, for each of the one or more CSI-RS resources in the CSI-RS resource set, explicitly indicates that the CSI-RS resource is associated to multiple TCI states.

7. The method of claim 5 wherein the information received from the network node that explicitly indicates the multiple TCI states associated to the one or more CSI-RS resources comprises, for each CSI-RS resource of the one or more CSI-RS resources, information in a CSI-RS resource configuration for the CSI-RS resource that explicitly indicates that the CSI-RS resource is associated to multiple TCI states.

8. The method of claim 7 wherein receiving the information comprises receiving the information via Radio Resource Control, RRC, signaling.

9. The method of claim 5 wherein the information received from the network node that explicitly indicates the multiple TCI states associated to the one or more CSI-RS resources comprises information comprised in an NZP-CSI-RS-Resource IE and/or a CSI-ReportConfig IE.

10. The method of claim 5 wherein the one or more CSI-RS resources are semi-persistent CSI-RS resources and the information received from the network node that explicitly indicates the multiple TCI states associated to the one or more CSI-RS resources comprises information comprised in a Medium Access Control, MAC, Control Element, CE, message used to activate and/or deactivate the one or more semi-persistent CSI-RS resources, wherein the information comprised in the MAC CE message comprises a list of TCI states that are to be associated to a respective semi-persistent NZP CSI-RS resource.

11. The method of claim 5 wherein the information received from the network node that explicitly indicates the multiple TCI states associated to the one or more CSI-RS resources comprises a list of TCI states configured to be associated with each of the one or more CSI-RS resources via RRC signaling.

12. The method of claim 5 wherein the information received from the network node that explicitly indicates the multiple TCI states associated to the one or more CSI-RS resources comprises information that explicitly links the set of CSI-RS resources, where each CSI-RS resource in the set of CSI-RS resources is associated with a separate TCI state.

13. The method of claim 1 wherein the information received from the network node implicitly indicates (a), (b), or (c) for the one or more CSI-RS ports.

14. The method of claim 1 wherein the information received from the network node implicitly indicates the multiple TCI states associated to the one or more CSI-RS resources.

15. The method of claim 14 wherein the information that implicitly indicates the multiple TCI states associated to the one or more CSI-RS resources comprises information that, for each CSI-RS resource of the one or more CSI-RS resources, implicitly associates the CSI-RS resource to multiple TCI states.

16. The method of claim 14 wherein the information that implicitly indicates the multiple TCI states associated to the one or more CSI-RS resources comprises information that implicitly links the set of CSI-RS resources, where each CSI-RS resource in the set of CSI-RS resources is associated with a separate TCI state.

17. The method of claim 14 wherein the information that implicitly indicates the multiple TCI states associated to the one or more CSI-RS resources comprises information that implicitly links the set of CSI-RS resources based on how CSI-RS resources in the set are configured.

18. (canceled)

19. A User Equipment, UE, for Channel State Information, CSI, feedback, the UE comprising:
one or more transmitters;
one or more receivers; and
processing circuitry associated with the one or more transmitters and the one or more receivers, the processing circuitry configured to cause the UE to:
receive, from a network node, information that explicitly or implicitly indicates, for one or more CSI Reference Signal, CSI-RS, ports in one or more CSI-RS resources in a CSI-RS resource set:
(a) multiple Transmission Configuration Indicator, TCI, states associated to each of the one or more CSI-RS resources,
(b) a single TCI state for each of multiple CSI-RS resources in the CSI-RS resource set, wherein the multiple CSI-RS resources are fully overlapping in time and frequency and each of the multiple CSI-RS resources is associated to a different TCI state; or
(c) a combination of (a) and (b);
based on the information received from the network node, perform channel measurement based on the one or more CSI-RS ports by:
(i) measuring each CSI-RS port that is in a CSI-RS resource that is associated to multiple TCI states using the multiple TCI states associated to the CSI-RS resource; and/or
(ii) measuring each CSI-RS port that is in the multiple CSI-RS resources each associated to a different TCI state over the multiple CSI-RS resources using the respective TCI states associated to the multiple CSI-RS resources;
determine a channel rank based on the channel measurement;
compute a channel quality based on the determined rank and the channel measurement; and
send, to the network node, feedback comprising information that indicates the rank and the channel quality.

20. (canceled)

21. A method performed by a network node, the method comprising:
sending, to a user equipment, UE, information that explicitly or implicitly indicates, for one or more CSI Reference Signal, CSI-RS, ports in one or more CSI-RS resources in a CSI-RS resource set:
(a) multiple Transmission Configuration Indication, TCI, states associated to each of the one or more CSI-RS resources,
(b) a single TCI state for each of multiple CSI-RS resources in the CSI-RS resource set, wherein the multiple CSI-RS resources are fully overlapping in time and frequency and each of the multiple CSI-RS resources is associated to a different TCI state; or
(c) a combination of (a) and (b).

22. A network node comprising processing circuitry configured to cause the network node to:
send, to a user equipment, UE, information that explicitly or implicitly indicates, for one or more CSI Reference Signal, CSI-RS, ports in one or more CSI-RS resources in a CSI-RS resource set:
(a) multiple Transmission Configuration Indication, TCI, states associated to each of the one or more CSI-RS resources,
(b) a single TCI state for each of multiple CSI-RS resources in the CSI-RS resource set, wherein the multiple CSI-RS resources are fully overlapping in time and frequency and each of the multiple CSI-RS resources is associated to a different TCI state; or
(c) a combination of (a) and (b).
